(19) United States
(12) Patent Application Publication
(10) Pub. No.: US 2014/0170917 A1
(43) Pub. Date: Jun. 19, 2014

(54) POLYURETHANE POLYMER, SYNTHETIC LEATHER, AND METHOD

(71) Applicant: 3M INNOVATIVE PROPERTIES COMPANY, St. Paul, MN (US)

(72) Inventors: Chetan P. Jariwala, Woodbury, MN (US); Wayne W. Fan, Cottage Grove, MN (US); Yongshang Lu, Woodbury, MN (US)

(73) Assignee: 3M INNOVATIVE PROPERTIES COMPANY, ST. PAUL, MN (US)

(21) Appl. No.: 13/719,467

(22) Filed: Dec. 19, 2012

(51) Int. Cl. D06N 3/14; C08G 18/06

(52) U.S. Cl. CPC D06N 3/14; C08G 18/06
USPC 442/85; 528/70

(57) ABSTRACT

A polyurethane polymer, a synthetic leather including such polymer, and a method of making such polymer, wherein the polyurethane polymer includes the reaction product of components including: a fluorinated mono-functional alcohol comprising a perfluorinated (C4-C6)alkyl group, a perfluorinated (C4-C6)alkylene group, or both; a fluorinated aliphatic diol comprising a perfluorinated (C4-C6)alkyl group, a perfluorinated (C4-C6)alkylene group, or both; a hydrocarbon diol; and a diisocyanate; wherein at least one of the following conditions is met: the total of the fluorinated aliphatic diol and the mono-functional alcohol is less than 2 wt-% of the components forming the polyurethane polymer; or the total fluorine content is less than 1 wt-% of the polyurethane polymer.

### BACKGROUND

Polyurethanes are widely used to make a wide variety of products, including synthetic leathers. These polyurethane-based synthetic leathers are mainly used in four product categories: footwear; upholstery such as for automotive seats, sofas, and chairs; personal goods such as handbags and gloves; and sporting goods such as soccer balls.

Many of these synthetic leather products and applications require stain resistant and hydrolysis resistant properties. For example, the water absorption and hydrolysis of the polyurethane (PU) can severely increase the weight of, and reduce the life of, a soccer ball. Thus, it is desirable to increase the hydrophobicity and hydrolysis resistance of the PU resin.

Accordingly, it has been a general practice for the synthetic leather polyurethane manufacturers to use a fluorochemical (FC) alcohol in the PU process to reduce the surface energy of the synthetic leathers. In the past 20 year or so, the synthetic leather polyurethane producers have used a C8-based fluorochemical alcohol, such as C₈F₁₇SO₂N(Et)CH₂CH₂OH and C₈F₁₇CH₂CH₂OH. Due to environmental concerns, the synthetic leather polyurethane producers and the fluorochemical alcohol manufacturers are actively looking for the replacement of these long chain fluorochemical alcohols. However, shorter chain fluorochemical alcohol analogs, such as C6 telomer (C₆F₁₃CH₂CH₂OH) and C4 sulfonamido alcohols (C₄F₉SO₂N(CH₃)C₂H₄OH), are lower in hydrolytic resistance performance. It is desired to develop a new fluorochemical alcohol with a short perfluorinated chain which can offer not only reduced environmental concerns but also the same or improved hydrophobic performance of the C8 alcohols in polyurethane resins.

### SUMMARY

The present disclosure provides a polyurethane polymer that has improved hydrophobic and hydrolysis resistant properties. Such improved properties result from the combination of a fluorochemical short chain alcohol and a fluorochemical short chain diol. Such polyurethane polymers are suitable for use in making synthetic leather.

In one embodiment, the present disclosure provides a polyurethane polymer that includes the reaction product of components including: a fluorinated mono-functional alcohol having a perfluorinated (C4-C6)alkyl group, a perfluorinated (C4-C6)alkylene group, or both; a fluorinated aliphatic diol having a perfluorinated (C4-C6)alkyl group, a perfluorinated (C4-C6)alkylene group, or both; a hydrocarbon diol; and a diisocyanate. In the resultant polyurethane polymer at least one of the following conditions is met: the total of the fluorinated aliphatic diol and the mono-functional alcohol is less than 2 wt-% of the components forming the polyurethane polymer; or the total fluorine content is less than 1 wt-% of the polyurethane polymer.

In one embodiment, the present disclosure provides synthetic leather that includes: a substrate (preferably, a fibrous substrate) having at least one surface; and a coating on the surface of the substrate; wherein the coating includes a polyurethane polymer as described herein.

The present disclosure also provides methods of forming a polyurethane polymer.

In one embodiment, a method of making a polyurethane polymer includes: providing components including: a fluorinated mono-functional alcohol having a perfluorinated (C4-C6)alkyl group, a perfluorinated (C4-C6)alkylene group, or both; a fluorinated aliphatic diol having a perfluorinated (C4-C6)alkyl group, a perfluorinated (C4-C6)alkylene group, or both; a hydrocarbon diol; and a diisocyanate; and combining the components in an organic solvent under conditions effective to form a polyurethane polymer. In the resultant polyurethane polymer at least one of the following conditions is met: the total of the aliphatic diol and the mono-functional alcohol is less than 2 weight percent (wt-%) of the components forming the polyurethane polymer; or the total fluorine content is less than 1 wt-% of the polyurethane polymer.

The term “perfluoroalkyl” or “perfluorinated alkyl” refers to an alkyl (i.e., “alkyl” refers to a monovalent group that is a radical of an alkane) with all the hydrogen atoms replaced with fluorine atoms, including linear, branched, or cyclic groups. Stated differently, all of the C—H bonds are replaced with C—F bonds.

The term “perfluoroalkylene” or “perfluorinated alkylene” refers to an alkylene (i.e., “alkylene” refers to a divalent group that is a radical of an alkane) with all the hydrogen atoms replaced with fluorine atoms, including linear, branched, or cyclic groups. Preferably, an alkylene and a perfluoroalkylene are straight chain (i.e., linear) groups. Stated differently, all of the C—H bonds are replaced with C—F bonds.

As used herein, the term “organic group” means a hydrocarbon group (with optional elements other than carbon and hydrogen, such as oxygen, nitrogen, sulfur, and silicon) that is classified as an aliphatic group, cyclic group, or combination of aliphatic and cyclic groups (e.g., alkaryl and aralkyl groups). In the context of the present invention, the organic groups are those that do not interfere with the formation of a polyurethane polymer. The term “aliphatic group” means a saturated or unsaturated linear or branched hydrocarbon group. This term is used to encompass alkyl, alkenyl, and alkynyl groups, for example. The term “alkyl group” means a saturated linear, branched, or cyclic hydrocarbon group including, for example, methyl, ethyl, isopropyl, t-butyl, heptyl, dodecyl, octadecyl, amyl, 2-ethylhexyl, and the like. The term “alkenyl group” means an unsaturated, linear, branched, or cyclic hydrocarbon group with one or more carbon-carbon double bonds, such as a vinyl group. The term “alkynyl group” means an unsaturated, linear, branched, or cyclic hydrocarbon group with one or more carbon-carbon triple bonds. The term “cyclic group” means a closed ring hydrocarbon group that is classified as an alicyclic group, aromatic group, or heterocyclic group. The term “alicyclic group” means a cyclic hydrocarbon group having properties resembling those of aliphatic groups. The term “aromatic group” or “aryl group” means a mono- or polynuclear aromatic hydrocarbon group. The term “araliphatic” means a group that includes both aromatic and aliphatic groups. The term “heterocyclic group” or “heteroaliphatic” or “heteroaromatic” means a cyclic, aliphatic, or aromatic group, respectively in which one or more of the atoms in the group is an element other than carbon (e.g., nitrogen, oxygen, sulfur, etc.).

The terms “comprises” and variations thereof do not have a limiting meaning where these terms appear in the description and claims.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and preferably by the term “exactly.” As used herein, in connection with a measured quantity, the term “about” refers to that variation in the measured quantity as would be expected by the skilled artisan making the measurement and exercising a level of care commensurate with the objective of the measurement and the precision of the measuring equipment used.

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

When a group is present more than once in a formula described herein, each group is “independently” selected, whether specifically stated or not. For example, when more than one R group is present in a formula, each R group is independently selected. Furthermore, subgroups contained within these groups are also independently selected. For example, when each R group contains a Y group, each Y is also independently selected.

As used herein, the term “room temperature” refers to a temperature of 20° C. to 25° C. or 22° C. to 25° C.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION OF EXEMPLARY EMBODIMENTS

The present disclosure provides a polyurethane polymer that has improved hydrophobic and hydrolysis resistant properties. Such improved properties result from the combination of a fluorochemical short chain alcohol (i.e., a fluorinated mono-functional alcohol having a perfluorinated (C4-C6)alkyl and/or alkylene group) and a fluorochemical short chain diol (i.e., a fluorinated aliphatic diol having a perfluorinated (C4-C6)alkyl and/or alkylene group). In this combination, the fluorochemical short chain diol contributes significantly to the improvement in such properties. Such polyurethane polymers are suitable for use in making synthetic leather.

The present disclosure provides a polyurethane polymer that includes the reaction product of components including: a fluorinated mono-functional alcohol having a perfluorinated (C4-C6)alkyl group, a perfluorinated (C4-C6)alkylene group, or both; a fluorinated aliphatic diol having a perfluorinated (C4-C6)alkyl group, a perfluorinated (C4-C6)alkylene group, or both; a hydrocarbon diol; and a diisocyanate. In the resultant polymer at least one of the following conditions is met: the total of the fluorinated aliphatic diol and the mono-functional alcohol is less than 2 wt-% of the components forming the polyurethane polymer; or the total fluorine content is less than 1 wt-% of the polyurethane polymer. In certain embodiments, both these conditions are met.

Such polymer can be used in a synthetic leather that includes a substrate (preferably, a fibrous substrate) having at least one surface and a coating including such polyurethane polymer on the surface of the substrate.

In certain embodiments, substantially no polyols of functionality of 3 or higher, whether fluorinated or nonfluorinated, are used in making a polyurethane of the disclosure. In this context, “substantially no” means less than 1 weight percent (wt-%) of the polyurethane (in certain embodiments, less than 0.5 wt-%, and in certain embodiments, less than 0.1 wt-%).

The resultant polyurethane polymers demonstrate improvement in hydrophobic and hydrolysis resistance properties, relative to polyurethane polymers prepared with the use of the fluorochemical short chain alcohol and no fluorochemical short chain diol, or with use of the fluorochemical short chain diol and no fluorochemical short chain alcohol, as represented by water absorption and contact angle testing. For example, in certain embodiments, the water contact angle of a polyurethane polymer coating of the present disclosure is greater than 95 degrees.

### Fluorinated Mono-Functional Alcohols

Fluorinated mono-functional alcohols are compounds that include one or more perfluorinated (C4-C6)alkyl and/or perfluorinated (C4-C6)alkylene groups. Such compounds can include other perfluorinated, partially fluorinated, or nonfluorinated groups (e.g., 5- or 6-membered aromatic rings or hydrocarbon alkylene groups), functional groups (e.g., sulfonamide, carboxyl, amine, or amide), and/or catenated heteroatoms (e.g., sulfur or oxygen), as long as there is at least one perfluorinated (C4-C6)alkyl or (C4-C6)alkylene group. In the resultant polyurethane polymer, the perfluorinated (C4-C6)alkyl group(s) are terminal groups from the resultant backbone or a branch therefrom.

Representative examples of suitable fluorinated mono-functional alcohols for use in preparing the polyurethane polymer of the present disclosure include, but are not limited to, those selected from the group of:

### C₄F₉SO₂N(CH₃)(CH₂)₂CH₂OH;

### C₄F₉SO₂N(CH₃)(CH₂)₄OH;

### R_{f}SO₂N(CH₃)CH₂CH₂OH;

### CF₃(CF₂)₃SO₂N(CH₃)CH(CH₃)CH₂OH;

### CF₃(CF₂)₃SO₂N(CH₃)CH₂CH₂OH;

### CF₃(CF₂)₃SO₂N(CH₃)CH₂CH(CH₃)OH;

### R_{f}SO₂N(H)(CH₂)₂OH;

### R_{f}SO₂N(CH₃)(CH₂)₄OH;

### C₆F₁₃SO₂N(CH₃)(CH₂)₄OH;

### R_{f}SO₂N(CH₃)(CH₂)₁₁OH;

### R_{f}SO₂N(C₂H₅)CH₂CH₂OH;

### CF₃ (CF₂)₃ SO₂N(C₂H₅)CH₂CH₂OH;

### CF₃(CF₂)₅SO₂N(C₂H₅)CH₂CH₂OH;

### R_{f}SO₂N(C₂H₅)(CH₂)₆OH;

### R_{f}SO₂N(C₂H₅)(CH₂)₁₁OH;

### R_{f}SO₂N(C₃H₇)CH₂OCH₂CH₂CH₂OH;

### R_{f}SO₂N(CH₂CH₂CH₃)CH₂CH₂OH;

### R_{f}SO₂N(C₄H₉)(CH₂)₄OH;

### R_{f}SO₂N(C₄H₉)CH₂CH₂OH;

### R_{f}CON(CH₃)CH₂CH₂OH;

### R_{f}CON(CH₃)(CH₂)₁₁OH;

### R_{f}CON(C₂H₅)CH₂CH₂OH;

### R_{f}CON(H)CH₂CH₂OH;

### C₄F₉O(CF(CF₃)CF₂O)₁₋₃₆CF(CF₃)CH₂OH;

### C₄F₉O(CF₂CF₂O)₁₋₃₆CF₂CH₂OH;

n-C₄F₉OC₂F₄OCF₂CH₂OCH₂CH₂OH;

### R_{f}COOCH₂CH₂OH;

### R_{f}(CH₂)₁₁N(C₂H₅)CH₂CH₂OH;

### R_{f}COOCH₂CH₂CH(CH₃)OH;

### C₅F₁₁COOCH₂CH₂OH;

perfluoro(cyclohexyl)methanol (i.e., C₆F₁₁CH₂OH);

### R_{f}CH₂CH₂SO₂N(CH₃)CH₂CH₂OH;

### CF₃(CF₂)₃CH₂CH₂SO₂N(CH₃)CH₂CH₂OH;

### C₄F₉(CH₂)₂S(CH₂)₂OH;

### R_{f}(CH₂)₂S(CH₂)₃OH;

### R_{f}(CH₂)₄SCH(CH₃)CH₂OH;

### R_{f}(CH₂)₂S(CH)₁₁OH;

### R_{f}(CH₂)₃O(CH₂)₂OH;

### R_{f}SO₂N(H)(C₂H₄)OC(O)(CH₂)₅OH;

### CF₃(CF₂)₅CH₂CH₂SO₂N(CH₃)CH₂CH₂OH;

### R_{f}(CH₂)₂S(CH₂)₂OH;

### R_{f}(CH₂)₄S(CH₂)₂OH;

### R_{f}(CH₂)₂SCH(CH₃)CH₂OH;

### R_{f}CH₂CH(CH₃)S(CH₂)₂OH;

### R_{f}(CH₂)₂S(CH₂)₃—O—(CH₂)₂OH;

### R_{f}(CH₂)₃ SCH(CH₃)CH₂OH;

### R_{f}CH₂CH₂SO₂—NR′R″OH; and

R_{f}(CH₂)ₙOH such as CF₃(CF₂)₅CH₂CH₂CH₂OH, CF₃(CF₂)₅CH₂CH₂OH, CF₃(CF₂)₅(CH₂)₆OH, C₄F₉CH₂CH₂OH, or C₅F₁₁CH₂OH;
wherein:

R_{f} is a perfluoroalkyl group having 4 to 6 carbon atoms;

R′ is an alkyl group having 1 to 4 carbon atoms;

R″ is an alkyl group having 1 to 11 carbon atoms; and

n can be no greater than 50 (in certain embodiments, n is 1 to 2).

In certain embodiments of the present disclosure, the mono-functional alcohol is CF₃(CF₂)₃SO₂N(CH₃)(CH₂)₂OH or CF₃(CF₂)ₘ(CH₂)ₙOH, wherein m is 3 to 5, and n can be no greater than 50, and in certain embodiments, n is 1 to 2.

Various mixtures of fluorinated mono-functional alcohols can be used if desired to prepare a polyurethane polymer of the present disclosure.

### Fluorinated Aliphatic Diols

Fluorinated aliphatic diols are compounds that include one or more perfluorinated (C4-C6)alkyl and/or perfluorinated (C4-C6)alkylene groups. Such compounds can include other perfluorinated, partially fluorinated, or nonfluorinated groups (e.g., 5- or 6-membered aromatic rings or hydrocarbon alkylene groups), functional groups (e.g., sulfonamide, carboxyl, amine, or amide), and/or catenated heteroatoms (e.g., sulfur or oxygen), as long as there is at least one perfluorinated (C4-C6)alkyl or (C4-C6)alkylene group. Thus, in this context, “aliphatic” refers to the perfluorinated (C4-C6) group.

Representative examples of suitable fluorinated aliphatic diols for use in preparing a polyurethane polymer of the present disclosure include, but are not limited to, those selected from the group of:

R_{f}SO₂N(CH₂CH₂OH)₂ such as N-bis(2-hydroxyethyl)perfluorobutylsulfonamide;

### R_{f}OC₆H₄SO₂N(CH₂CH₂OH)₂;

R_{f}SO₂N(R′)CH₂CH(OH)CH₂OH such as C₆F₁₃SO₂N(C₃H₇)CH₂CH(OH)CH₂OH;

### R_{f}CH₂CON(CH₂CH₂OH)₂;

### R_{f}CON(CH₂CH₂OH)₂;

R_{f}OCH₂CH(OH)CH₂OH such as C₄F₉OCH₂CH(OH)CH₂OH;

### R_{f}CH₂CH₂SC₃H₆OCH₂CH(OH)CH₂OH;

### R_{f}CH₂CH₂SC₃H₆CH(CH₂OH)₂;

### R_{f}CH₂CH₂SCH₂CH(OH)CH₂OH;

### R_{f}CH₂CH₂SCH(CH₂OH)₂;

R_{f}(CH₂)₃SCH₂CH(OH)CH₂OH such as C₅F₁₁(CH₂)₃SCH₂CH(OH)CH₂OH;
R_{f}(CH₂)₃OCH₂CH(OH)CH₂OH such as C₅F₁₁(CH₂)₃OCH₂CH(OH)CH₂OH;

### R_{f}CH₂CH₂CH₂OC₂H₄OCH₂CH(OH)CH₂OH;

### R_{f}CH₂CH(CH₃)OCH₂CH(OH)CH₂OH;

### R_{f}CH₂CH₂OCH₂CH(OH)CH₂OH;

### R_{f}(CH₂)₄SC₃H₆CH(CH₂OH)₂;

### R_{f}(CH₂)₄SCH₂CH(CH₂OH)₂;

### R_{f}(CH₂)₄SC₃H₆OCH₂CH(OH)CH₂OH;

### R_{f}CH₂CH(C₄H₉)SCH₂CH(OH)CH₂OH;

### R_{f}CH₂OCH₂CH(OH)CH₂OH;

### R_{f}CH₂CH(OH)CH₂SCH₂CH₂OH;

### R_{f}CH₂CH(OH)CH₂OCH₂CH₂OH;

### R_{f}CH₂CH(OH)CH₂OH;

HO(CH₂)ₓ—R_{f}—(CH₂)_{y}OH such as HOCH₂—R_{f}—CH₂OH and HOCH₂CH₂—R_{f}—CH₂CH₂OH;

### R_{f}R″SCH(R′″—OH)CH(R′″—OH)SR″R_{f};

### (R_{f}R″SCH₂)₂C(CH₂OH)₂;

### R_{f}CH₂CH₂SO₂N(R′″—OH)₂;

### (R_{f}CH₂CH₂SCH₂CH₂SCH₂)₂C(CH₂OH)₂; and

1,4-bis(1-hydroxy-1,1-dihydroperfluoroethoxyethoxy)perfluoro-n-butane;
wherein:

R_{f} is a perfluoroalkyl group having 4 to 6 carbon atoms;

R_{f′} is a perfluoroalkylene group having 4 to 6 carbon atoms;

R′ is an alkyl group having 1 to 4 carbon atoms;

R″ is an alkylene group (preferably, straight chain) having 1 to 12 carbon atoms, alkylenethio-alkylene group having 2 to 12 carbon atoms, alkylene-oxyalkylene group having 2 to 12 carbon atoms, or alkylene iminoalkylene group having 2 to 12 carbon atoms, where the nitrogen atom contains as a third substituent hydrogen or an alkyl group having 1 to 6 carbon atoms;

R′″ is an alkylene group (preferably, straight chain) having 1 to 12 carbon atoms (or 1 to 11 carbon atoms);

x is 1 or 2; and

y is 1 or 2.

In certain embodiments of the present disclosure, the fluorinated aliphatic diol is CF₃(CF₂)₃SO₂N(C₂H₄OH)₂ or HO(CH₂)ₓ(CF₂)_{w}(CH₂)_{y}OH, wherein w is 4 to 6, x is 1 or 2, and y is 1 or 2.

Various mixtures of fluorinated aliphatic diols can be used if desired to prepare a polyurethane polymer of the present disclosure.

### Hydrocarbon Diols

Representative examples of suitable hydrocarbon diols (i.e., non-fluorinated diols) suitable for use in preparing the polyurethane polymer of the present disclosure include, but are not limited to, organic diols wherein the hydroxyl groups can be primary or secondary, with primary hydroxyl groups being preferred for their greater reactivity. Suitable hydrocarbon diols include those having at least one aliphatic, heteroaliphatic, alicyclic, heteroalicyclic, aromatic, heteroaromatic, or polymeric moiety. Preferred hydrocarbon diols are aliphatic or polymeric diols that contain hydroxyl groups as terminal groups.

Exemplary hydrocarbon diols include, but are not limited to, those selected from the group of: glycols of low molecular weight, such as ethylene glycol, 1,2-propylene glycol, 1,3-propylene glycol, 1,4-butylene glycol, and 1,6-hexamethylene glycol; polyester diols obtained from dibasic acids, such as adipic acid, maleic acid, and terephthalic acid; polyester diols, such as polylactones obtained by subjecting lactones to ring-opening polymerization with glycols; polycarbonate diols; polyether diols, such as polytetramethylene glycol, polyethylene glycol, and polypropylene glycol; and diols having pendant long chain alkyl groups, such as glycerol monostearate and RN(C₂H₄OH)₂ where R is (C12-C18)alkyl groups.

In certain embodiments, polyurethane polymers of the present disclosure are prepared from two or more different hydrocarbon diols.

### Diisocyanates

Suitable diisocyanates include diisocyanate-containing compounds that include aliphatic, alicyclic, aromatic, and araliphatic groups.

Examples of useful aliphatic diisocyanate compounds include, but are not limited to, those selected from the group of tetramethylene 1,4-diisocyanate, hexamethylene 1,4-diisocyanate, hexamethylene 1,6-diisocyanate (HDI), octamethylene 1,8-diisocyanate, diisocyanatododecane, 2,2,4-trimethyl-hexamethylene diisocyanate (TMDI), 2-methyl-1,5-pentamethylene diisocyanate, dimer diisocyanate, the urea of hexamethylene diisocyanate, the biuret of hexamethylene 1,6-diisocyanate (HDI) (available under the trade names DESMODUR N-100 and N-3200 from Bayer Corp., Pittsburgh, Pa.), the isocyanurate of HDI (available under the trade names DESMODUR N-3300 and N-3600 from Bayer Corp., Pittsburgh, Pa.), a blend of the isocyanurate of HDI and the uretdione of HDI (available under the trade name DESMODUR N-3400 from Bayer Corp., Pittsburgh, Pa.), and mixtures thereof.

Examples of useful alicyclic diisocyanate compounds include, but are not limited to, those selected from the group of dicyclohexylmethane diisocyanate (H₁₂MDI, commercially available under the trade name DESMODUR, from Bayer Corporation, Pittsburgh, Pa.), 4,4′-isopropyl-bis(cyclohexylisocyanate), isophorone diisocyanate (IPDI), cyclobutane-1,3-diisocyanate, cyclohexane 1,3-diisocyanate, cyclohexane 1,4-diisocyanate (CHM), 1,4-cyclohexanebis(methylene isocyanate) (BDI), dimmer acid diisocyanate (available from Bayer), 1,3-bis(isocyanatomethyl)cyclohexane (H₆XDI), 3-isocyanatomethyl-3,5,5-trimethylcyclohexyl isocyanate, and mixtures thereof.

Examples of useful aromatic, diisocyanates include, but are not limited to, those selected from the group of toluene-2,4-diisocyanate (TDI), 4-methoxy-1,3-phenylene diisocyanate, 4-isopropyl-1,3-phenylene diisocyanate, 4-chloro-1,3-phenylene diisocyanate, 4-butoxy-1,3-phenylene diisocyanate, 2,4-diisocyanatodiphenyl ether, 4,4′-methylenebis(phenyl-isocyanate) (MDI), polymeric MDI, durylene diisocyanate, tolidine diisocyanate, xylylene diisocyanate (XDI), 1,5-naphthalene diisocyanate, benzidine diisocyanate, o-nitrobenzidine diisocyanate, 4,4-diisocyanatodibenzyl, and mixtures thereof. In certain embodiments, diisocyanates include those selected from the group of tetramethylene 1,4-diisocyanate, hexamethylene 1,4-diisocyanate, hexamethylene 1,6-diisocyanate (HDI), octamethylene 1,8-diisocyanate, 1,12-diisocyanatododecane, and mixtures thereof.

Examples of useful araliphatic diisocyanates include, but are not limited to, those selected from the group of m-tetramethyl xylylene diisocyanate (m-TMXDI), p-tetramethyl xylylene diisocyanate (p-TMXDI), 1,4-xylylene diisocyanate (XDI), 1,3-xylylene diisocyanate, p-(1-isocyanatoethyl)phenyl isocyanate, m-(3-isocyanatobutyl)phenyl isocyanate, 4-(2-isocyanatocyclohexyl-methyl)phenyl isocyanate, and mixtures thereof.

In certain embodiments, the diisocyanate is an aromatic diisocyanate. In certain embodiments the aromatic diisocyanate is diphenylmethane-4,4′-diisocyanate (4,4′-MD or polymeric MDI.

Various mixtures of diisocyanates can be used if desired to prepare a polyurethane polymer of the present disclosure.

### Optional Reactive Components

In certain embodiments, the polyurethane polymers of the present disclosure can be made using hydrocarbon chain extenders, flexible hydrocarbon components, or both. Such compounds are distinct from the hydrocarbon diols. Although in certain embodiments, substantially no polyols of functionality of 3 or higher, whether fluorinated or nonfluorinated, are used in making a polyurethane of the disclosure, in certain embodiments such optional reactive components can include nonfluorinated triols or tetrols, for example.

Representative examples of useful polymeric nonfluorinated polyols include polyoxyethylene, polyoxypropylene, and ethylene oxide-terminated polypropylene triols of molecular weights from 200 to 2000, corresponding to equivalent weights of 70 to 700 for triols; polytetramethylene glycols of varying molecular weight; hydroxy-terminated polyesters and hydroxy-terminated polylactones (e.g., polycaprolactone polyols); hydroxy-terminated polyalkadienes (e.g., hydroxyl-terminated polybutadienes); and the like. Mixtures of polymeric polyols can be used if desired.

Useful commercially available nonfluorinated polymeric polyols include poly(ethylene glycol) materials in the number average molecular weight (Mn) range of from 200 to 2000 (available under the trade name CARBOWAX from Union Carbide Corp.); poly(propylene glycol) materials such as PPG-425 (available from Lyondell Chemicals); block copolymers of poly(ethylene glycol) and poly(propylene glycol) (available under the trade name PLURONIC L31 from BASF Corporation); Bisphenol A ethoxylate, Bisphenol A propyloxylate, and Bisphenol A propoxylate/ethoxylate (available from SigmaAldrich); polytetramethylene ether glycols (available under the trade name POLYMEG 650 and 1000 from Quaker Oats Company); hydroxyl-terminated polybutadiene resins (available the trade name POLY BD from Elf Atochem); polyoxyalkylene tetrols having secondary hydroxyl groups (available under the trade name PEP from Wyandotte Chemicals Corp., for example, PEP 450, 550, and 650); polycaprolactone polyols with Mn in the range of 200 to 2000 (available under the trade name TONE from Union Carbide, for example, TONE 0201, 0210, 0301, and 0310); polyester polyols such as poly(ethyleneadipate)polyols (available under the trade name MULTRON from Mobay Chemical Co.); and mixtures thereof.

### Methods

The polyurethane polymer of the present disclosure can be made using conventional techniques, for example, by combining the components in an organic solvent, under conditions effective to form a polyurethane polymer. Suitable organic solvents include dimethylformamide (DMF), N-methylpyrollidone (NMP), methyl ethyl ketone (MEK), ethylacetate, as well as other polar nonreactive solvents. A preferred solvent is DMF.

Various ratios of the components used to prepare the polyurethane polymer of the present disclosure can be used as can be determined by one of skill in the art.

In certain embodiments, the weight ratio of the fluorinated aliphatic diol to the fluorinated mono-functional alcohol is at least 1:9. In certain embodiments, the weight ratio of the fluorinated aliphatic diol to the fluorinated mono-functional alcohol is no greater than 9:1.

In certain embodiments, the weight ratio of the fluorinated aliphatic diol to the fluorinated mono-functional alcohol is at least 1:3. In certain embodiments, the weight ratio of the fluorinated aliphatic diol to the fluorinated mono-functional alcohol is no greater than 1:1.

The amounts of the hydrocarbon diols, diisocyanates, and optional reactive components can be varied depending on the flexibility of the desired polyurethane. Typically, the amount (in moles) of hydrocarbon diol is calculated based on the moles of isocyanate minus the hydroxyl number of the fluorinated aliphatic diol and fluorinated mono-functional alcohol.

Conditions effective to form a polyurethane polymer include, for example, mixing the components and heating (e.g., 60° C. to 80° C.), optionally using a catalyst (e.g., dibutyltindilaurate, amines, or combinations thereof) to speed the reaction. The reaction is typically carried out until the isocyanate is completely reacted.

The resultant polymer can be coated onto a substrate. Coating compositions of the present disclosure can include organic solvents. Suitable organic solvents include, but are not limited to, dimethylformamide, glycol ethers, amides, ketones, hydrocarbons, hydrofluorocarbons, hydrofluoroethers, chlorohydrocarbons, chlorocarbons, and mixtures thereof. Conventional coating methods suitable for coating a solvent-containing coating composition can be used.

### Synthetic Leather

Synthetic leather typically includes a substrate and a coating on at least one surface of the substrate. The coating includes a polyurethane polymer of the present disclosure, and often a colorant (e.g., a pigment or dye).

The substrate can be any suitable substrate, such as a fibrous substrate. In certain embodiments, the substrate is a textile material. Suitable textiles include, but are not limited to, woven textiles, knit textiles, and non-wovens. The textiles can be made from suitable natural fibers, synthetic fibers, or combinations thereof.

In certain embodiments, the substrate is a nonwoven.

In certain embodiments, substrate includes a material selected from polypropylene, cotton, nylon, polyester, polyethylene, and combinations thereof.

In order to promote adhesion between the substrate and the coating, the substrate can include a precoat layer on the surface to which the coating is applied. The precoat layer includes a material that promotes adhesion between the substrate and the coating, as is known in the art.

The colorant can be dispersed within the polyurethane polymer or copolymerized to produce a colored polyurethane polymer. Examples of suitable colorants are disclosed, for example, in U.S. Pat. No. 7,662,461.

In certain embodiments, a polyurethane polymer of the present disclosure provides synthetic leather that is flexible and durable, while providing the properties representative of real leather.

### Illustrative Embodiments

1. A polyurethane polymer comprising the reaction product of components comprising:
   a fluorinated mono-functional alcohol comprising a perfluorinated (C4-C6)alkyl group, a perfluorinated (C4-C6)alkylene group, or both;
   a fluorinated aliphatic diol comprising a perfluorinated (C4-C6)alkyl group, a perfluorinated (C4-C6)alkylene group, or both;
   a hydrocarbon diol; and
   a diisocyanate;
   wherein at least one of the following conditions is met:
   the total of the fluorinated aliphatic diol and the mono-functional alcohol is less than 2 wt-% of the components forming the polyurethane polymer; or
   the total fluorine content is less than 1 wt-% of the polyurethane polymer.
2. The polyurethane polymer of embodiment 1 wherein the weight ratio of the fluorinated aliphatic diol to the fluorinated mono-functional alcohol is 1:9 to 9:1.
3. The polyurethane polymer of embodiment 1 or 2 wherein the weight ratio of the fluorinated aliphatic diol to the fluorinated mono-functional alcohol is 1:3 to 1:1.
4. The polyurethane polymer of any one of embodiments 1 through 3 which is the reaction product of components further comprising a second and different hydrocarbon diol.
5. The polyurethane polymer of any one of embodiments 1 through 4 wherein the diisocyanate is aromatic.
6. The polyurethane polymer of any one of embodiments 1 through 5 wherein the fluorinated mono-functional alcohol is CF₃(CF₂)₃SO₂N(CH₃)(CH₂)₂OH or CF₃(CF₂)ₘ(CH₂)ₙOH, wherein m is 3 to 5 and n is no greater than 50 (preferably, n is 1 to 2).
7. The polyurethane polymer of anyone of embodiments 1 through 6 wherein the fluorinated aliphatic diol is CF₃(CF₂)₃SO₂N((CH₂)₂OH)₂ or HO(CH₂)ₓ(CF₂)_{w}(CH₂)_{y}OH, wherein w is 4 to 6, x is 1 or 2, and y is 1 or 2.
8. The polyurethane polymer of any one of embodiments 1 through 7 which is the reaction product of components further comprising a hydrocarbon chain extender, a flexible hydrocarbon component, or both.
9. The polyurethane polymer of any one of embodiments 1 through 8 which is the reaction product of substantially no polyols of functionality 3 or higher, whether fluorinated or nonfluorinated.
10. The polyurethane polymer of any one of embodiments 1 through 9 wherein the water contact angle as measured on a coating comprising the polyurethane polymer is greater than 95 degrees.
11. Synthetic leather comprising:
   a substrate having at least one surface; and
   a coating on the surface of the substrate;
   wherein the coating comprises a polyurethane polymer of any one of claims 1 through 10.
12. Synthetic leather of embodiment 11 wherein the water contact angle as measured on the coating is greater than 95 degrees.
13. Synthetic leather of embodiment 11 or 12 wherein the substrate is a fibrous substrate.
14. Synthetic leather of embodiment 13 wherein the fibrous substrate comprises a material selected from polypropylene, cotton, nylon, polyester, polyethylene, and combinations thereof.
15. A method of making a polyurethane polymer comprising:
   providing components comprising:
      a fluorinated mono-functional alcohol comprising a perfluorinated (C4-C6)alkyl group, a perfluorinated (C4-C6)alkylene group, or both;
      a fluorinated aliphatic diol comprising a perfluorinated (C4-C6)alkyl group, a perfluorinated (C4-C6)alkylene group, or both;
      a hydrocarbon diol; and
      a diisocyanate; and
   combining the components in an organic solvent under conditions effective to form a polyurethane polymer;
   wherein at least one of the following conditions is met:
      the total of the fluorinated aliphatic diol and the mono-functional alcohol is less than 2 wt-% of the components forming the polyurethane polymer; or
      the total fluorine content is less than 1 wt-% of the polyurethane polymer.
16. The method of embodiment 15 wherein the organic solvent is dimethylformamide.
17. The method of embodiment 15 or 16 wherein the weight ratio of the fluorinated aliphatic diol to the fluorinated mono-functional alcohol is 1:9 to 9:1.
18. The method of any one of embodiments 15 through 17 wherein the weight ratio of the fluorinated aliphatic diol to the fluorinated mono-functional alcohol is 1:3 to 1:1.
19. The method of any one of embodiments 15 through 18 wherein the components further comprise a second and different hydrocarbon diol.
20. The method of any one of embodiments 15 through 19 wherein the diisocyanate is aromatic.
21. The method of any one of embodiments 15 through 20 wherein the mono-functional alcohol is CF₃(CF₂)₃SO₂N(CH₃)(CH₂)₂OH or CF₃(CF₂)ₘ(CH₂)ₙOH, wherein m is 3 to 5 and n is no greater than 50 (preferably, n=1-2).
22. The method of any one of embodiments 15 through 21 wherein the fluorinated aliphatic diol is CF₃(CF₂)₃SO₂N((CH₂)₂OH)₂ or HO(CH₂)ₓ(CF₂)_{w}(CH₂)_{y}OH, wherein w is 4 to 6, x is 1 or 2, and y is 1 or 2
23. The method of any one of embodiments 15 through 22 wherein the components further comprise a hydrocarbon chain extender, a flexible hydrocarbon component, or both.
24. The method of any one of embodiments 15 through 23 wherein the components comprise substantially no polyols of functionality 3 or higher, whether fluorinated or nonfluorinated.
25. The method of any one of embodiments 15 through 24 wherein the water contact angle as measured on a coating comprising the polyurethane polymer is greater than 95 degrees.

### EXAMPLES

Objects and advantages of this disclosure are further illustrated by the following examples, but the particular materials and amounts thereof recited in these examples, as well as other conditions and details, should not be construed to unduly limit this disclosure.

The following examples are merely for illustrative purposes and are not meant to limit in any way the scope of the appended claims. All parts, percentages, ratios, and the like in the examples are by weight, unless noted otherwise. Unit abbreviations used include h=hours, g=grams, wt=weight. Unless otherwise stated, materials were obtained from Sigma-Aldrich, Milwaukee, Wis.

### Materials

| DESCRIPTION | SOURCE |
|---|---|
| C4-alcohol, C₄F₉SO₂N(CH₃)C₂H₄OH | A fluorochemical alcohol having an |
| | equivalent weight of 357, can be made in |
| | two stages by reacting C₄F₉SO₂F, |
| | (perfluorobutanesulfonyl fluoride, available |
| | from Sigma-Aldrich, Milwaukee, WI) with |
| | methylamine and ethylenechlorohydrin, |
| | using a procedure essentially as described |
| | in Example 1 of U.S. Pat. No. 2,803,656 |
| | (Ahlbrecht, et al.). |
| C4-diol, C₄F₉SO₂N(C₂H₄OH)₂ | A fluorochemical diol, can be prepared as |
| | described in Example 8 of U.S. Pat. No. |
| | 3,787,351 (Olson), except that an equimolar |
| | amount of C₄F₉SO₂NH₂ is substituted for |
| | C₈F₁₇SO₂NH₂. |
| EtFOSE, C₈F₁₇SO₂N(Et)C₂H₄OH | Can be made in two stages by reacting |
| | C₈F₁₇SO₂F with methylamine and |
| | ethylenechlorohydrin, using a procedure |
| | essentially as described in Example 1 of |
| | U.S. Pat. No. 2,803,656 (Ahlbrecht et al.), |
| | or alternatively, by reacting N- |
| | ethylperfluorooctylsulfonamide with |
| | ethylene carbonate, using the procedure |
| | essentially as described in Example 7 of |
| | U.S. Pat. No. 3,734,962 (Niederprum et at.). |
| C₆F₁₃C₂H₄OH (C6-alcohol) | Commercially available from Clariant |
| | Corp., Muttenz, Switzwerland under the |
| | trade name FLOWET EA-600. |
| C₈F₁₇C₂H₄OH (C8-alcohol) | Commercially available from Clariant |
| | Corp., Muttenz, Switzwerland under the |
| | trade name FLOWET EA-800. |
| Methylene diphenyl diisocyanate (MDI) | Sigma-Aldrich, St. Louis, MO. |
| Polypropylene glycol (P1200) | Sigma-Aldrich, St. Louis, MO. |
| 1,4-butanediol (1,4-BDO) | Alfa-Aesar, Ward Hill, MA. |
| Dimethylformamide | EMD Chemicals, Philadelphia, PA. |

### Contact Angle Measurement

Contact angle measurement was done with a Drop Shape Analysis System DSA-100 (Kruss, Hamburg, Germany) with digital image analysis software.

### Comparative Example 1

No fluoro alcohols (diols or mono-functional alcohols) were used in this Comparative Example.

MDI (13.88 g) and P1200 (33.3 g) were added to a three-necked flask equipped with a mechanical stirrer, nitrogen inlet and condenser. The molar ratio between the NCO groups of the MDI and the OH groups of the P1200 was 2.0. The reaction was carried out at 70° C. for 1 hour under a dry nitrogen atmosphere, and 2.28 g of 1,4-BDO and 30 g DMF were added to the system for the chain extension reaction and the viscosity reduction, respectively. After an additional 2 h of reaction, 85 g DMF was added to the reactants and then the reactants were cooled down to 20° C. to obtain PPG-based polyurethane with 30% solid in DMF. The clear, flexible, tough polyurethane films were obtained by drying the PU solution at 80° C. in a TEFLON mold. The contact angle was measured as described under “Contact Angle Measurement” and is shown in Table 1.

### Comparative Examples 2-6

Either just a fluoro diol (i.e., fluorinated aliphatic diol) or just a mono-functional fluoro alcohol (i.e., fluorinated mono-functional alcohol) was used in these Comparative Examples. All reaction mixtures used 0.66-0.67 wt-% total sum percentage of the fluorinated aliphatic diol and the mono-functional alcohol based on the polyurethane polymer.

Comparative Example 1 was repeated except with the amounts of MDI, PPG1200 and 1.4-BDO shown in Table 1. As shown in Table 1, Comparative Examples 2-4 additionally had monofunctional alcohols (C8-alcohol, C6-alcohol and a different C8 alcohol respectively) added to the DMF. Comparative Example 5 additionally had C4-diol (but no monofunctional alcohol) added to the DMF. Comparative example 6 additionally had C4-alcohol (monofunctional alcohol) but no fluoro diol added to the DMF. In all the Comparative Examples the molar ratio between the NCO groups of the MDI and the OH groups of the P 1200 was 2.0 except for Comparative Example 6 where it was 1.05. In all cases the resulting PU was 30% solids in DMF and a clear, flexible, tough PU film was obtained after drying. The contact angles were measured as described under “Contact Angle Measurement” and are shown in Table 1. All contact angles were 96 degrees or less except Comparative Example 2 which used the C8-alcohol.

### Examples 1-6

These Examples used both a fluoro diol and a mono-functional fluoro alcohol in combination in very low amounts. All reaction mixtures used 0.66 wt-% total sum percentage of the fluorinated aliphatic diol and the mono-functional alcohol based on the polyurethane polymer.

Comparative Example 1 was repeated but with the materials and amounts shown in Table 2. Examples 1-3 had combinations of C4-diol and C4-alcohol added to the DMF while Examples 4-6 had combinations of C4-diol and C6-alcohol added to the DMF. In all these Examples the molar ratio between the NCO groups of the MDI and the OH groups of the P1200 was 2.0. In all cases the resulting PU was 30% solids in DMF and a clear, flexible, tough PU film was obtained after drying. The contact angles were measured as described under “Contact Angle Measurement” and are shown in Table 1. All contact angles were 97 degrees or greater.

TABLE 1

| | | | | | | | | | Water |
|---|---|---|---|---|---|---|---|---|---|
| | | | 1,4 | C8- | C6- | Et- | C4- | C4- | Contact |
| | MDI | PPG1200 | BDO | alcohol | alcohol | FOSE | diol | alcohol | Angle |
| Ex | (g) | (g) | (g) | (g) | (g) | (g) | (g) | (g) | (degrees) |
| CE1 | 13.88 | 33.3 | 2.28 | 0.00 | 0.00 | 0.00 | 0.00 | 0.00 | 76 |
| CE2 | 14.69 | 33.0 | 2.25 | 0.33 | 0.00 | 0.00 | 0.00 | 0.00 | 102 |
| CE3 | 14.69 | 33.0 | 2.26 | 0.00 | 0.33 | 0.00 | 0.00 | 0.00 | 94 |
| CE4 | 13.90 | 33.0 | 2.25 | 0.00 | 0.00 | 0.33 | 0.00 | 0.00 | 96 |
| CE5 | 14.19 | 33.0 | 2.41 | 0.00 | 0.00 | 0.00 | 0.33 | 0.00 | 90 |
| CE6 | 14.19 | 33.0 | 2.31 | 0.00 | 0.00 | 0.00 | 0.00 | 0.33 | 91 |
| EX1 | 14.12 | 33.0 | 2.30 | 0.00 | 0.00 | 0.00 | 0.22 | 0.11 | 97 |
| EX2 | 14.09 | 33.0 | 2.35 | 0.00 | 0.00 | 0.00 | 0.17 | 0.17 | 99 |
| EX3 | 14.06 | 33.0 | 2.29 | 0.00 | 0.00 | 0.00 | 0.11 | 0.22 | 101 |
| EX4 | 14.09 | 33.0 | 2.30 | 0.00 | 0.17 | 0.00 | 0.17 | 0.00 | 102 |
| EX5 | 14.12 | 33.0 | 2.29 | 0.00 | 0.11 | 0.00 | 0.22 | 0.00 | 107 |
| EX6 | 14.05 | 33.0 | 2.28 | 0.00 | 0.22 | 0.00 | 0.11 | 0.00 | 107 |

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

What is claimed is:

1. A polyurethane polymer comprising the reaction product of components comprising:
a fluorinated mono-functional alcohol comprising a perfluorinated (C4-C6)alkyl group, a perfluorinated (C4-C6)alkylene group, or both;
a fluorinated aliphatic diol comprising a perfluorinated (C4-C6)alkyl group, a perfluorinated (C4-C6)alkylene group, or both;
a hydrocarbon diol; and
a diisocyanate;
wherein at least one of the following conditions is met:
the total of the fluorinated aliphatic diol and the mono-functional alcohol is less than 2 wt-% of the components forming the polyurethane polymer; or
the total fluorine content is less than 1 wt-% of the polyurethane polymer.

2. The polyurethane polymer of claim 1 wherein the weight ratio of the fluorinated aliphatic diol to the fluorinated mono-functional alcohol is 1:9 to 9:1.

3. The polyurethane polymer of claim 1 wherein the weight ratio of the fluorinated aliphatic diol to the fluorinated mono-functional alcohol is 1:3 to 1:1.

4. The polyurethane polymer of claim 1 which is the reaction product of components further comprising a second and different hydrocarbon diol.

5. The polyurethane polymer of claim 1 wherein the diisocyanate is aromatic.

6. The polyurethane polymer of claim 1 wherein the fluorinated mono-functional alcohol is CF₃(CF₂)₃SO₂N(CH₃)(CH₂)₂OH or CF₃(CF₂)ₘ(CH₂)ₙOH, wherein m is 3 to 5 and n is no greater than 50.

7. The polyurethane polymer of claim 1 wherein the fluorinated aliphatic diol is CF₃(CF₂)₃SO₂N((CH₂)₂OH)₂ or HO(CH₂)ₓ(CF₂)_{w}(CH₂)_{y}OH, wherein w is 4 to 6, x is 1 or 2, and y is 1 or 2

8. Synthetic leather comprising:
a substrate having at least one surface; and
a coating on the surface of the substrate;
wherein the coating comprises a polyurethane polymer of claim 1.

9. Synthetic leather of claim 8 wherein the water contact angle as measured on the coating is greater than 95 degrees.

10. Synthetic leather of claim 8 wherein the substrate is a fibrous substrate.

11. Synthetic leather of claim 10 wherein the fibrous substrate comprises a material selected from polypropylene, cotton, nylon, polyester, polyethylene, and combinations thereof.

12. A method of making a polyurethane polymer comprising:
providing components comprising:
a fluorinated mono-functional alcohol comprising a perfluorinated (C4-C6)alkyl group, a perfluorinated (C4-C6)alkylene group, or both;
a fluorinated aliphatic diol comprising a perfluorinated (C4-C6)alkyl group, a perfluorinated (C4-C6)alkylene group, or both;
a hydrocarbon diol; and
a diisocyanate; and
combining the components in an organic solvent under conditions effective to form a polyurethane polymer;
wherein at least one of the following conditions is met:
the total of the fluorinated aliphatic diol and the mono-functional alcohol is less than 2 wt-% of the components forming the polyurethane polymer; or
the total fluorine content is less than 1 wt-% of the polyurethane polymer.

13. The method of claim 12 wherein the organic solvent is dimethylformamide.

14. The method of claim 12 wherein the weight ratio of the fluorinated aliphatic diol to the fluorinated mono-functional alcohol is 1:9 to 9:1.

15. The method of claim 12 wherein the diisocyanate is aromatic.
